(19) United States
(12) Patent Application Publication
(10) Pub. No.: US 2016/0081409 A1
(43) Pub. Date: Mar. 24, 2016

(54) ARTICLE AND METHOD FOR THE PRODUCTION THEREOF

(71) Applicant: Harry Loester, Aalen (DE)

(72) Inventor: Harry Loester, Aalen (DE)

(21) Appl. No.: 14/883,987

(22) Filed: Oct. 15, 2015

Related U.S. Application Data
(63) Continuation of application No. PCT/EP2014/057580, filed on Apr. 15, 2014.

(30) Foreign Application Priority Data
Apr. 15, 2013 (DE) 10 2013 206 639.2

(51) Int. Cl. A41D 27/08; G09F 19/12

(52) U.S. Cl. CPC A41D 27/08; G09F 19/12

(57) ABSTRACT

In an article (1) made of a soft material, in particular a textile material, leather or the like, at least one section of the surface (2) of the article (1) is provided with a lenticular print (3).

The invention relates to an article made of a soft material, in particular a textile material, leather and the like, and a method for the production of an article made of a soft material, in particular a textile material, leather or the like.

Textiles, such as, for example, T-shirts, jeans or else underwear, are known from the general prior art in an extremely wide range of designs. In the course of various fashion trends, such textiles have changed again and again, specifically both as regards the materials thereof and also the outer appearance thereof.

The same is also true of accessories such as bags or schoolbags, which are frequently subject to changing fashion trends.

If specific motifs are to be applied to T-shirts, bags or the like, for example, then different printing processes can be used, although these will not be discussed extensively here.

DE 27 30 785 A1 describes an optical system having a transparent surface structure which is formed with a flat surface on one side and with numerous parallel grid lens ribs on the opposite side. Provided in the region of the flat surface of the transparent surface structure is a partial image, which is composed of a plurality of parallel stripes arranged at intervals from one another, which form image lines and between which there are arranged transparent strips through which the light can pass. The optical system can, inter alia, be arranged on clocks or items of clothing.

U.S. 2009/0153959 discloses a composite lens grid film having a first layer with a first refractive index and a second layer with a second refractive index which is lower than the first refractive index. The first layer has at least one row of projecting lenses; the second layer is formed in one piece with the first layer. The composite lens grid film can, inter alia, be attached to a fabric.

DE 10 2010 009 906 A1 describes a method for screening color separations of a lenticular image having a lenticular frequency of the lenticular lenses that are required for the viewing of the lenticular image.

U.S. 2006/0250696 A1 relates to an indicating device which has an off-axis combiner and two plastic lenses. One of the lenses is a rotationally symmetrical optical element, and the other lens is a non-rotationally symmetrical optical element.

DE 20 2009 002 186 U1 describes a bag, in particular a shoulder bag, having at least one flat pocket, wherein at least one of the walls of the one pocket is transparent, at least in some areas, and forms an outer wall of the bag.

It is an object of the present invention to devise an article made of a soft material, in particular a textile material, leather or the like, and a method for the production of such an article which offers new styling possibilities.

According to the invention, this object is achieved by the features cited in claim 1.

As a result of the lenticular print on at least one section of the surface of the article according to the invention, a completely novel effect can be implemented on such an article made of soft material, such as, for example, a textile material, leather or the like. The article according to the invention opens up a multiplicity of styling possibilities which have not been known hitherto. In addition to T-shirts, sweatshirts, jackets, trousers and the like, such a lenticular print can also be provided on bags or schoolbags, whereby the value of such articles can be increased considerably.

In order to produce a secure connection of the lenticular print to the article, the invention provides for the lenticular print to be connected to the article by means of an adhesive layer.

Furthermore, according to the invention provision is made for the adhesive layer to have an adhesive which has a processing temperature of at most 120° C. Such an adhesive having such a low processing temperature permits a secure connection of the lenticular print to the article without the covering layer having the lenses and/or prisms being damaged.

An alternative achievement of the object results from the features of claim 2.

The fact that the lenticular print is applied directly to the surface of the article results in a lower thickness of the article according to the invention in the area of the lenticular print applied to the same.

In a very advantageous development of the invention, provision can be made for the lenticular print to have an image and a covering layer having lenses and/or prisms covering the image. In this way, the advantageous effect of such a lenticular or lens print or prism print or image, specifically the production of a three-dimensional effect or of a shaking or changing image, is established in a particularly advantageous way.

A method for the production of the article according to the invention is specified in claim 4. By using this method, the article according to the invention can be produced in a simple and reliable manner.

In order to achieve a secure connection between the lenticular print and the article, provision is made for the lenticular print to be adhesively bonded to the surface.

Furthermore, in the method according to the invention, provision is made that, before the adhesive bonding of the lenticular print, an image is applied to an underlayer and covered with a covering layer having lenses and/or prisms. As a result, the lenticular print or the lenticular image can be connected very simply to the article.

Due to the fact that provision is additionally made for the lenticular print to be adhesively bonded on by means of an adhesive which has a processing temperature of at most 120° C., a sufficiently firm connection of the lenticular print to the article is achieved without there being any danger that the covering layer having the lenses and/or prisms is damaged.

An alternative method is specified in claim 5.

Here, provision is made for an image of the lenticular print to be applied directly to the surface of the article and to be covered with a covering layer having lenses and/or prisms. As a result of such a direct application of the lenticular print to the surface of the article, firstly an otherwise necessary adhesive and an otherwise necessary underlayer and secondly the method step of adhesively bonding the lenticular print to the article can be saved. A further advantage of this solution lies in the lower thickness of the print which can be achieved in this way.

Exemplary embodiments of the invention are illustrated in principle below by using the drawing.

The drawings show:

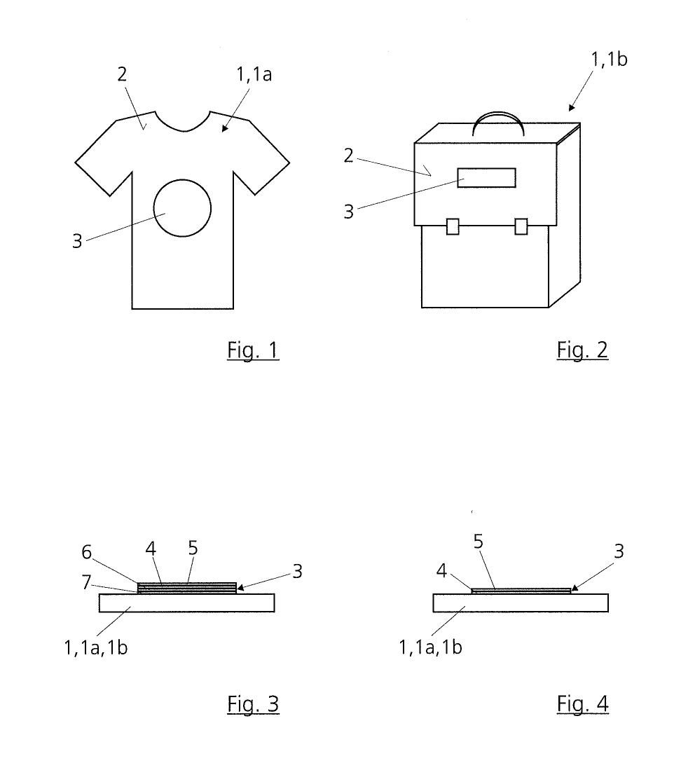

FIG. 1 a first embodiment of the article according to the invention;

FIG. 2 a second embodiment of the article according to the invention;

FIG. 3 a first embodiment of a method for the production of the article from FIG. 1 or FIG. 2; and

FIG. 4 a second embodiment of a method for the production of the article from FIG. 1 or FIG. 2.

FIG. 1 shows an article 1 made of a soft material, in the present case a T-shirt 1a. The T-shirt 1a consists of a textile material, such as, for example, cotton, polyester, polyamide or another material normally used for T-shirts. Alternatively, the article 1 formed as an item of clothing could also be a sweatshirt, shirt, trousers, a jacket, an item of underwear, a swimming costume or another item of clothing. Depending on the intended use, a suitable textile material or possibly also leather is used here.

The article 1 or, in the practical exemplary embodiment, the T-shirt la has a lenticular print 3 at least on one section of its surface 2. Such a lenticular print 3, which is known in principle, is also designated as a lens print or prism print or as a lenticular image, lens image or prism image. In the present case, the lenticular print 3 is located on the front side of the T-shirt, but it would also be possible to apply the same to another point of the T-shirt 1a. In FIG. 1 no motif of the lenticular print 3 is illustrated, since in principle any motif can be used.

FIG. 2 shows a further article 1 which, in this case, is formed as a schoolbag 1b, on the surface 2 of which there is likewise a lenticular print 3. Of course, the lenticular print 3 can also have any other desired shape in both cases. The same applies to the lenticular print 3 of the schoolbag 1b as was explained above for the lenticular print 3 of the T-shirt 1a. The schoolbag 1b can consist of a textile material, in particular a synthetic fiber, but also of PVC, of leather or of another suitable soft material. Instead of being implemented as a schoolbag 1b, the article 1 can also be implemented as a bag, such as, for example, a shoulder bag, handbag or else as a rucksack or the like. In particularly in the case of the schoolbag 1b or in general in the case of a bag or a similar accessory, the lenticular print 3 can additionally be further edged with a seam, not illustrated.

The term “soft material” means any material which exhibits a certain elasticity or flexibility. If, as can be the case in the schoolbag 1b, for example, this material has been stiffened by additional measures or elements, for example by the insertion of paperboard or the like, this is nevertheless viewed as “soft material”, since the surface 2 of the article 1 is unchanged. In principle, it would also be possible to apply the lenticular print 3 to an article made of a hard material, such as for example to a serving tray or a thermos flask.

Two different types of application of the lenticular print 3 to the article 1 are illustrated in FIGS. 3 and 4. Each of the methods described below and each of the embodiments of the lenticular print 3 can be used both in the T-shirt la and in the schoolbag lb and in all other conceivable articles 1.

The common factor in both embodiments of FIGS. 3 and is that the lenticular print 3 is in each case applied to a flexible base and has an image layer or image 4 and a covering layer 5 having lenses and/or prisms, which are not specifically illustrated. The image 4 represents the visible image of the lenticular print 3. The covering layer 5, by way of the lenses and/or prisms, ensures the specific effect of the lenticular print 3, namely a three-dimensional effect or the effect of a so-called shaking or changing image. In the case of the changing images, the so-called morphing effect can occur. The effect brought about by the lenses and/or prisms results from the change in the viewing angle of an observer onto the surface of the lenticular print 3.

In the embodiment illustrated in FIG. 3, the image 4 is located on an underlayer 6, onto which it has been printed, for example. The underlayer 6 can consist, for example, of polypropylene, PVC or another suitable material, in particular plastic. The printing process used for this purpose can be known per se and, for this reason, will not be described in more detail herein.

Following the application of the image 4 to the underlayer 6, the covering layer 5 is applied over the image 4. The combination of the underlayer 6, the image 4 and the covering layer 5 is then connected to the article 1, i.e. adhesively bonded, by means of an adhesive layer 7.

The adhesive layer 7 has an adhesive which preferably has a processing temperature of at most 120° C. or consists of such an adhesive. In other words, in order to bond the lenticular print 3 comprising the underlayer 6, the image 4 and the covering layer 5, the article 1 and/or the lenticular print 3 is subjected to a temperature of up to 120° C. in order to activate the adhesive of the adhesive layer 7 and to produce a secure adhesive connection. During bonding, the adhesive layer 7 is preferably applied to the underlayer 6, after which the underlayer 6 is or pressed onto the article 1. However, it is of course also possible to apply the adhesive layer 7 to the article 1.

The adhesive used for the adhesive layer 7 is in particular a low-viscosity adhesive substance with a good resistance to hydrolysis, high thermal resistance, good cold flexibility and a soft textile feel. The density of the adhesive can be about 1.2 g per cm³, the viscosity about 10,000 mPas at 100° C. and 5000 mPas at 120° C.

In the embodiment illustrated in FIG. 4, the image 4 is applied directly to the surface 2 of the article 1 and then covered with the covering layer 5. The lenses and/or prisms can be produced simultaneously with the application of the covering layer 5, in or on the same. To produce the lenses and/or prisms, it is possible to use a tool which deforms the covering layer 5, which is liquid in this case, and forms the lenses and/or prisms in the process. In the embodiment in FIG. 4, the lenticular print 3 is accordingly applied directly to the surface 2 of the article 1 and it is thus possible to dispense both with the underlayer 6 and with the adhesive layer 7.

1. An article made of a soft material, in particular a textile material, leather and the like, at least one section of the surface (2) of the article (1) being provided with a lenticular print (3),
characterized in that
the lenticular print (3) is connected to the article (1) by means of an adhesive layer (7), wherein the adhesive layer (7) has an adhesive which has a processing temperature of at most 120° C.

2. An article made of a soft material, in particular a textile material, leather and the like, at least one section of the surface (2) of the article (1) being provided with a lenticular print (3),
characterized in that
the lenticular print (3) is applied directly to the surface (2) of the article (1).

3. The article as claimed in claim 1 or 2,
characterized in that
the lenticular print (3) has an image (4) and a covering layer (5) having lenses and/or prisms covering the image (4).

4. A method for the production of an article made of a soft material, in particular a textile material, leather or the like, a lenticular print (3) being applied to at least one section of the surface (2) of the article (1),
characterized in that
the lenticular print (3) is adhesively bonded to the surface (2), wherein, before the adhesive bonding of the lenticular print (3), an image (4) is applied to an underlayer (6) and covered with a covering layer (5) having lenses and/or prisms, and wherein the lenticular print (3) is adhesively bonded on by means of an adhesive (7) which has a processing temperature of at most 120° C.

5. A method for the production of an article made of a soft material, in particular a textile material, leather or the like, a lenticular print (3) being applied to at least one section of the surface (2) of the article (1),
characterized in that
an image (4) of the lenticular print (3) is applied directly to the surface (2) of the article (1) and is covered with a covering layer (5) having lenses and/or prisms.
